(19) United States
(12) Patent Application Publication
(10) Pub. No.: US 2026/0357982 A1
(43) Pub. Date: Nov. 12, 2026

(54) METHOD AND SYSTEM FOR CALIBRATING THE PARAMETERS OF A DEVICE FOR AUTOMATICALLY CONTROLLING A FURNACE

(71) Applicant: SAINT-GOBAIN ISOVER, COURBEVOIE (FR)

(72) Inventors: Thibault GUILLET, SOLLENTUNA (SE); Guillaume BARBA ROSSA, COURBEVOIE (FR)

(21) Appl. No.: 19/484,694

(22) PCT Filed: May 21, 2024
(86) PCT No.: PCT/EP2024/063930

§ 371 Date: Nov. 14, 2025

(30) Foreign Application Priority Data
May 23, 2023 (FR) FR2305081

(51) Int. Cl. F23N 1/00; C03B 5/235; C03B 5/24

(52) U.S. Cl. CPC F23N 1/002; C03B 5/2356; C03B 5/24; F23N 2221/10; F23N 2225/08; F23N 2225/26

(57) ABSTRACT

A method for calibrating the parameters of a device for automatically controlling a furnace for melting a mixture of raw materials including mineral waste. The method makes it possible to obtain optimal values for the parameters of the transfer function of the control device. It is based on modeling the thermal behavior of the furnace using a non-stationary heat transfer function H(s) with, as input data, variations as a function of time in the temperature ΔT of the mixture of molten raw materials; the variations being measured following modification, for a given and limited period of time, of at least one operating parameter of the furnace selected from the moisture content in the mixture of raw materials, the pull of the furnace, the charging rate of the mixture of raw materials, the power of the heating system, and/or the amount of organic compounds or of carbon-containing fuels in the mixture.

### TECHNICAL FIELD

The present invention relates to a method and to a system for calibrating the parameters of a device for automatically controlling a furnace, preferably a submerged-combustion furnace, for melting a mixture of raw materials comprising mineral waste. It also relates to a furnace, preferably a submerged-combustion furnace, which implements said method or said system.

### TECHNICAL BACKGROUND

It is common practice to use a submerged-combustion furnace (SCF), also known as a submerged-burner furnace (SBF), for melting a mixture of vitrifiable raw materials. In this type of furnace, means of combustion such as oxygen/air-fuel burners are directly submerged in the mixture of vitrifiable raw materials and in the molten glass melt formed. The direct injection, in the form of a flow, of reagents and gaseous combustion products into the glass melt, followed by their expansion and their rapid ascent, accelerates melting and improves the homogeneity of the melt.

U.S. Pat. No. 351,413 B, J. T. WAINWRIGHT Oct. 26, 1886 discloses, for example, a method of injecting air and/or fuel such as gas or oil into a molten glass melt so that said gases circulate and heat through the melt before their combustion takes place below or proximate to the surface of the melt. The melt is thus constantly stirred and mixed, allowing it to remain hot.

U.S. Pat. No. 1,656,828 A, POWELL EDWARD R, Jan. 1, 1928 discloses a method and device for manufacturing rock wool wherein a mixture of raw materials is introduced into a vertical tank provided with an adjacent inclined combustion chamber. The combustion chamber comprises a burner arranged in such a way that the combustion gases penetrate and melt the mixture of raw materials at the bottom of the tank. An opening at the base of the tank allows the molten glass to flow through an air jet for blowing the molten glass in the form of fibers.

FR 876569 A, UNION DES VERRERIES MECANIQUES, Nov. 10, 1942 discloses a submerged-combustion furnace comprising a vertical tank fitted, in its lower part, with at least one submerged burner with a combustion fluid pressure of more than 0.2 atmospheres and a rate greater than 30 meters per second.

WO 2009 091 558 A1, GAS TECHNOLOGY INST [US] Jul. 29, 2009 discloses a submerged-combustion furnace comprising a double-walled tank with fluid circulation. The furnace hearth is equipped with a plurality of submerged burners whose relative spatial arrangement is optimized to improve the thermal homogeneity of the glass melt and reduce the number of unmolten areas.

In addition to the tank suitable for melting the mixture of vitrifiable raw materials, a submerged-combustion furnace may comprise one or more other tanks adjacent to and in communication with the first tank, into which the molten glass flows from the first tank to undergo various treatments such as, especially, refining.

DE 651 687 C, GLASHUETTE ACHERN A G, Oct. 18, 1937 discloses a furnace comprising a vertical and rotating melting tank fed with raw materials through a top opening using a hopper. The tank comprises a submerged burner at the center of its lower base, oriented according to the axis of revolution of the tank, and is provided, at the periphery of said lower base, with openings allowing glass to flow towards a lower refining tank.

GB 1 028 481 A, SELAS CORP OF AMERICA, May 4, 1966 discloses a furnace equipped with a plurality of melting tanks, each comprising a number of submerged burners in the center of their lower base. The furnace also comprises a main refining tank into which the molten glass from the melting tanks flows.

In the context of manufacturing mineral fibers, the mixture of vitrifiable raw materials used in a submerged-combustion furnace comprises mineral materials that are sources of oxides, hydroxides and/or carbonates of metals, metalloids, alkalis and/or alkaline earths, the relative proportions of which are adjusted to obtain the desired chemical composition of the glass at the end of the melting process.

The mineral materials are generally mining materials such as, for example, silica sand, bauxite, dolomite, calcium carbonates, magnesium carbonates and/or sodium carbonate. They can also be mineral co-products from other manufacturing industries.

However, with the aim of reducing the ecological impact of manufacturing industries, especially by reducing the exploitation of natural resources, energy consumption and greenhouse gas emissions, it is now common practice to substitute all or part of the raw materials in the mixture with so-called recyclable mineral waste.

A first example of recyclable mineral waste is “cullet”, of which two types can be distinguished:
so-called “internal” cullet, which may include glass waste from the same manufacturing process or the same glass product production line and generally comprises cutting scraps, defective products detected and rejected during quality control or during product composition adjustments;
so-called “external” cullet, which may include glass waste collected from other processes or manufacturing lines for glass products, from consumers with the aim of recycling glass products after use, for example, demolition waste, glass bottles, used glazing, etc.

Typically, and more so in the case of external cullet, cullet is a mixture of scrap glass of different colors and compositions. The surface of this scrap may also be covered with organic and/or inorganic layers, which are the result of various processes used to functionalize surfaces for certain glass product applications. Finally, cullet may also contain a certain amount of foreign scrap such as ceramics, earthenware, porcelain, terracotta, plastic, metals, electronic components, etc.

A second example of recyclable mineral waste is mineral fiber waste with or without sizing, that is, with or without an organic binder. This waste may come from manufacturing industries, building sites or other works and/or recycling channels.

A third example of recyclable mineral waste are the raw materials derived from biomass of plant, animal, bacterial or fungal origin. This material can be used as fuel, but also as a means of adjusting the composition of glass and/or its redox state.

Depending on its source, recyclable mineral waste, especially external waste, has varying levels of moisture and/or organic materials. When introduced into the furnace, this moisture and these organic materials modify the thermal and chemical balance of the furnace and cause sudden variations in the temperature of the glass melt. The processes of refining and redox balancing of the glass melt are also disrupted. The stationary heating and refining mode of the furnace is thus destabilized. This is likely to result in lower yields and the production of glass products that are not suitable for the intended applications, especially for manufacturing mineral fibers.

It is therefore common practice to pre-treat mineral waste in order to reduce or even eliminate the moisture and organic compounds it contains.

WO 0248612 A1, SAINT GOBAIN [FR] Jun. 20, 2002 discloses, for example, a method for destroying and/or making mineral waste inert, making it possible especially to obtain cullet that can be reused for the subsequent manufacture of mineral wool. In this method, mineral waste is introduced into a liquid and/or foamy phase maintained at a temperature of at least 800 °C and previously formed in a tank fitted with a submerged burner from a mixture of partly vitrifiable materials.

WO 2006 018 582 A1, SAINT GOBAIN ISOVER [FR] Feb. 23, 2006 discloses a method for treating mineral waste, in particular mineral fiber waste, wherein pure oxygen or oxygen-enriched air is injected into a mass of materials to be recycled, itself subjected to heating via submerged burners. By virtue of the combustion of organic compounds and the melting of the mass, it is possible to obtain cullet that can be recycled for the subsequent manufacture of glass fibers.

U.S. Pat. No. 4,877,449 A, INST GAS TECHNOLOGY [US] Oct. 31, 1989 discloses a submerged-combustion furnace comprising a vertical tank with a cooled grate at the top, above the glass melt, onto which solid charges are deposited using a hopper. The combustion gases from the glass melt pass through the grate and heat the solid charges, causing them to melt and the resulting liquid to flow into the glass melt.

Alternatively, glass waste can be introduced directly, that is without prior treatment, into the glass melt of a furnace, especially a submerged-combustion furnace intended for manufacturing mineral fibers. Generally, a control device, such as a feedback regulation loop, is used for at least one operating, functioning or control parameter of the furnace, to compensate for disturbances to which the furnace is subjected in relation to its stationary mode. Such an approach is made possible by the very low thermal inertia intrinsic to submerged-combustion furnaces, in particular those equipped with a double-wall with fluid circulation.

EP 2 433 911 A1, JOHNS MANVILLE [US] Mar. 28, 2012 discloses a method and device for recycling a glass wool mat, wherein said mat is introduced into the glass melt of a submerged-combustion furnace at a uniform charging rate. A PID control device or a predictive control system allows the regulation, at output, of several operating parameters of the furnace, in particular the speed of the mat conveyors, based on different input signals, such as the temperature of the glass melt, the pull and/or the flow of fuel and/or oxidizer in the burners.

WO 2022/180 345 A1, SAINT GOBAIN ISOVER [FR] Sep. 1, 2022 discloses a method for regulating a submerged-combustion furnace fed with a moist mixture of mineral wool and/or biomass, wherein the mixture charging rate or the power of the submerged burners is regulated using a PID control device based on a measurement of the moisture level in said mixture.

### SUMMARY OF THE INVENTION

### Technical Problem

A major disadvantage of the methods that comprise a preliminary treatment step for recyclable mineral waste is that they require more complex installations or treatments, and therefore more substantial material and financial investments for their implementation.

It is therefore advantageous to favor methods and systems based on directly introducing, that is, without prior treatment, a mixture of raw materials comprising mineral waste into the furnace. The particularity of these methods and systems is that they require implementing and configuring control systems and processes, such as feedback loops, or predictive control systems.

However, despite the progress made in automating the configuration and calibration of control systems, said automation remains challenging for furnaces, especially submerged-combustion furnaces, for melting a mixture of raw materials comprising mineral waste.

The moisture level and organic compound content of mineral waste can vary significantly depending on its origin and how it is stored. Thus, over the course of the operating time of a furnace, especially a submerged-combustion furnace, a mixture of raw materials comprising mineral waste in given proportions is highly prone to sudden and significant variations in its moisture level and its content of organic compounds.

Additionally, the proportion of mineral waste in the mixture is likely to vary according to the ease or difficulty of sourcing raw materials. These variations can also contribute to sudden and significant variations in the moisture level and content of organic compounds in the mixture. As explained previously, such variations cause major disturbances to the thermal and chemical balance of the furnace. The furnace goes out of its stationary mode and may shift to unstable modes.

It is also common practice to add carbon-based organic mineral fuels, generally solid, to the mixture 1001a of raw materials. These fuels consist of an additional source of energy for the furnace, and are often derived from energy recovery processes. The type and amount of fuel can be highly variable depending on its origin and market availability. A typical example of fuel can be coal or petroleum coke.

However, it has been found that automatically configured and calibrated control systems are typically not capable of correcting or compensating, in a rapidly convergent manner and with limited setpoint overshoot amplitudes, the disturbances caused by sudden and intense variations in the moisture level and the content of organic compounds or carbon-containing fuels present in the mixture of raw materials.

Therefore, there is still a need for a method and system that can reliably and effectively calibrate the control devices of a furnace, especially a submerged-combustion furnace, and allow a rapidly convergent response to sudden and intense variations in the moisture level and/or the content of organic compounds or carbon-containing fuels in a mixture of raw materials comprising mineral waste.

### Solution to the Technical Problem

In a first aspect of the invention, a method is provided for calibrating the parameters of a device for automatically controlling a furnace, preferably a submerged-combustion furnace, for melting a mixture of raw materials comprising mineral waste
said furnace comprising at least one tank equipped with at least one heating means, preferably in the form of at least one submerged burner, and at least one control device configured to regulate the power of said heating means according to a setpoint temperature, T0;
said tank being suitable for melting a mixture of raw materials;
said tank comprising at least one temperature-measuring device;
said temperature-measuring device being configured to continuously measure the temperature of said mixture of molten raw materials, and connected to said control device;
said method comprises the following steps:
(a) continuously introducing a mixture of raw materials of a given composition into the tank;
(b) continuously measuring the temperature of the mixture of molten raw materials using the temperature-measuring device;
(c) stationary heating of the mixture of molten raw materials to a given temperature, Ti;
(d) modifying, for a given and limited period of time, without active regulation by the control device, at least one operating parameter of the furnace selected from among the moisture content in the mixture of raw materials, the pull of the furnace, the charging rate of the mixture of raw materials, the power of the heating means, and/or the amount of organic compounds or carbon-containing fuels in the mixture of raw materials;
(e) measuring variations as a function of time in the temperature, ΔT, of the mixture of molten raw materials and in the power ΔP of the heating means;
(f) modeling, using a data processing device, the thermal behavior of the furnace using a non-stationary heat transfer function H(s) with, as input data, the variations as a function of time in the temperature ΔT of the mixture of molten raw materials and of the at least one operating parameter modified in step (d);
(g) modeling, using a data processing device, the parameters of the transfer function C(s) of the control device applied to the transfer function H(s) modeled in step (f).

According to other advantageous embodiments:
the non-stationary heat transfer function H(s) is modeled using a first-order response transfer function with or without lag time;
in step (d), at least two parameters, preferably three parameters, are modified sequentially or in parallel;
in step (d), the moisture content in the mixture of raw materials is modified so that the variation in the moisture content of said mixture is between 0 and 10%, and/or the pull of the furnace is modified so that the relative variation of said pull is between 0 and 2000 kg/h;
in step (d), the amount of organic compounds or carbon-containing fuels in the mixture of raw materials is modified so that the relative variation of said amount of organic compounds or carbon-containing fuels is between 0 and 15% by weight, preferably between 0 and 10% by weight;
in step (d), the power of the heating means is modified so that the relative variation of said power with respect to the initial power is between 0 and 100%, preferably 0 and 50%, or even between 0 and 25%;
the control device is a Proportional-Integral-Derivative (PID) regulator;
in step (g), the furnace transfer function H(s) further takes, as input data, a set of simulated values, I(s), of variations in the moisture content in the mixture of raw materials, the pull of the furnace, the charging rate of the mixture of raw materials, the amount of organic compounds or carbon-containing fuels and/or the value of the setpoint temperature, T0;
the values of the moisture content in the mixture of raw materials, the pull of the furnace, the charging rate of the mixture of raw materials, and/or the amount of organic compounds or carbon-containing fuels are simulated as a random signal, such as white noise or pink noise.

The method according to the invention can be used for calibrating the parameters of a device for automatically controlling a furnace, preferably a submerged-combustion furnace, for melting a mixture of raw materials comprising mineral waste.

In other words, the invention also relates to using a method according to the invention for calibrating a device for automatically controlling a furnace, preferably a submerged-combustion furnace, for melting a mixture of raw materials comprising mineral waste.

In a second aspect of the invention, a system is provided for calibrating the parameters of a device for automatically controlling a furnace, preferably a submerged-combustion device, for melting a mixture of raw materials comprising mineral waste,
the furnace comprises at least one tank equipped with at least one heating means in the form of at least one submerged burner;
the tank is suitable for melting a mixture of raw materials;
said system comprises:
at least one temperature-measuring device, said temperature-measuring device being configured to continuously measure the temperature of said mixture of molten raw materials;
at least one control device configured to regulate the power of said heating means; the parameters of the transfer equation C(s) of said control device being calibrated using a method according to the invention.

In a third aspect of the invention, a furnace is provided, especially a submerged-combustion furnace, for melting a mixture of raw materials comprising mineral waste, wherein a method according to the first aspect of the invention is implemented.

The furnace, preferably a submerged-combustion furnace, for melting a mixture of raw materials comprising mineral waste, said furnace comprising:
a first tank suitable for melting a mixture of raw materials and equipped with at least one heating means in the form of at least one submerged burner,
at least one temperature-measuring device configured to continuously measure the temperature of said mixture of molten raw materials;
at least one control device configured to regulate the power of said heating means and to receive at least one continuous temperature measurement using said temperature-measuring device; the values of the parameters of the transfer function C(s) of the control device being fixed from values obtained using a calibration method according to the invention.

According to other advantageous embodiments:
the furnace is such that the heating means is an oxygen/air-fuel submerged burner and the control device is further configured to regulate the power of said submerged burner by adjusting the fuel flow rate injected into said burner while maintaining a constant oxygen flow rate to fuel flow rate ratio;
   the furnace is such that the heating means is an oxygen/air-fuel submerged burner and the control device is further configured to inject oxygen or air according to a constant total flow rate of oxygen or air into said burner and into a bubbler, and according to a constant oxygen or air flow rate to fuel flow rate ratio into the burner as the power of the submerged burner varies

In a fourth aspect of the invention, an installation is provided for manufacturing mineral fibers comprising a submerged-combustion furnace according to the fourth aspect of the invention.

### Advantages of the Invention

A first notable advantage of the invention is obtaining optimal values for the parameters of the transfer function of the control device of a submerged-combustion furnace. When the furnace is controlled by a control device calibrated in this way, the furnace temperature converges rapidly to the setpoint temperature of the furnace in the event of sudden and intense variations in the setpoint temperature, T₀, the moisture content in the mixture 1001a of raw materials, the pull of the furnace, the charging rate of the mixture 1001a of raw materials, and/or the amount of organic compounds or carbon-containing fuels in the mixture 1001a of raw materials.

A second notable advantage is that it is possible to model or even simulate different values for the parameters of the transfer function of the control device and to select those that allow optimal regulation of the furnace without the need to physically implement disturbance tests on the furnace to evaluate said calibration. Adjusting the control device therefore entails less stress on the furnace.

### BRIEF DESCRIPTION OF THE DRAWINGS

FIG. 1 is a schematic depiction of an example of a manufacturing line for glass or rock fiber.

FIG. 2 is a schematic cross-sectional depiction of a submerged-combustion furnace for melting a mixture of raw materials comprising mineral waste.

FIG. 3 is a flowchart of a method according to the first aspect of the invention.

FIG. 4 is a pictorial depiction of the temperature evolution of a submerged-combustion furnace based on the time elapsed after a sudden power reduction.

FIG. 5 is an example of a block diagram of a control device according to certain embodiments.

FIG. 6 is a pictorial depiction of an example of the temporal evolution of the power, expressed as a variation relative to base power, linked to variations as a function of time in the moisture content (upper frame) and the amount of organic compounds or carbon-containing fuels (lower frame).

FIG. 7 is a pictorial depiction of the temporal evolution of power (lower frame) and temperature (continuous line, upper frame) of a furnace in which the transfer function parameters of its automatic control system have been previously adjusted in accordance with the invention.

FIG. 8 is a pictorial depiction of the temporal evolution of the temperature (upper frame) and the power (middle frame) of a furnace based on the variations in the moisture content and amount of organic materials in the mixture of raw materials, and the pull of the furnace.

### DETAILED DESCRIPTION OF EMBODIMENTS

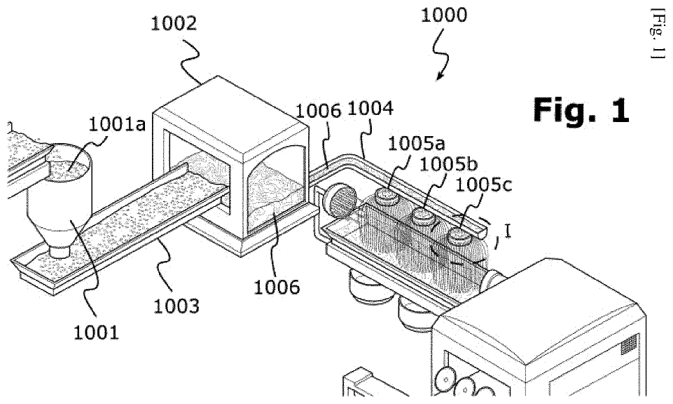

Referring to FIG. 1, a line 1000 for manufacturing glass or rock fibers by the internal centrifugal method generally comprises:
silos 1001 for storing the raw materials 1001a, for example mineral compounds and/or cullet;
a glass or rock melting furnace 1002 for melting the raw materials 1001a;
a conveyor 1003 for transporting the raw materials 1001a from the silos 1001 to the furnace 1002;
one or more fiber-forming tools 1005a, 1005b, 1005c fed with molten glass or rock 1006;
an open or closed feed channel 1004 provided with openings located just above each fiber-forming tool 1005a, 1005b, 1005c to feed them with molten glass or rock 1006.

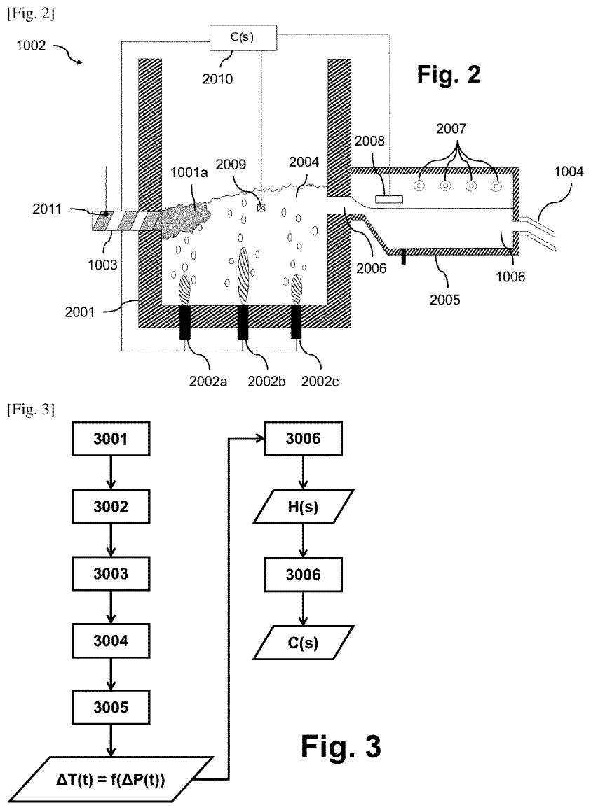

Referring to FIG. 2, a submerged-combustion furnace 1002 generally comprises at least one refractory melting tank 2001 fitted at its base with a series of submerged burners 2002a-c of the oxidizer-fuel type, for example oxygen-gas, air-fuel or oxygen-fuel. The furnace 1002 is fed with a mixture 1001a of raw materials by a screw conveyor 1003 via an opening in its side wall. The opening can be submerged or emerged. The submerged burners 2002a-c melt the mixture 1001a and stir the melt 2004.

The furnace 1002 may comprise a second tank 2005, for example a refining tank, into which the melt 2004 flows via a throat 2006 provided for this purpose. The second tank 2005 can be equipped with a plurality of flame burners 2007 arranged above the surface of the melt 2004, with submerged or non-submerged electrodes and with a means 2008 for supplying refining, oxidizing and/or reducing agents. The means 2088 for supplying the oxidizing or reducing agent may also be arranged in the first tank 2001.

The retention period of the melt 2004 in the second tank serves to further homogenize it thermally and chemically, and to adjust its redox state in accordance with the specifications. At the end of this retention period, the melt 2004 forms the molten glass or rock 1006, which is then conveyed to forming tools, such as fiber-forming tools 1005a-c via the channel 1004, glass aggregate manufacturing tools, or molding tools.

The melting tank 2001 is provided with a temperature-measuring device 2009, for example a thermocouple 2007, submerged or not, configured for continuously measuring the temperature, T, of said mixture 1001a of molten raw materials, that is the melt 2004. The temperature-measuring device is generally connected to a control device 2010, such as a Proportional-Integral-Derivative (PID) regulator, which allows the furnace to be regulated according to a setpoint temperature, T₀. The setpoint temperature, T₀, can be a fixed value or a temporal profile.

The control device 2010 is connected to the submerged burner controllers (not shown) and adjusts the power so that the temperature, T, of the melt 2004 reaches the setpoint temperature, T₀. In the case of oxygen-fuel burners, the power of the burners is adjusted by varying the flow rates of oxygen, fuel and/or the ratio of these two flow rates.

The control device 2010 can be further configured to control the amount or flow rate of oxidizing and reducing agent supplied via the supply means 2008. This control can be exercised via a connection to the control device (not shown) of the supply means 2008. For example, if the supply means 2008 is a conveyor, the control device can vary the conveying speed according to a setpoint value provided by the control device 2010.

Referring to FIG. 2 and FIG. 3, in a first aspect of the invention, a method 3000 is provided for calibrating the parameters of a device 2010 for automatically controlling a furnace 1002, preferably a submerged-combustion furnace, for melting a mixture 1001a of raw materials comprising mineral waste,
said furnace 1002 comprising at least one tank 2001 equipped with at least one heating means 2002a-c, preferably in the form of at least one submerged burner, and at least one control device 2010 configured to regulate the power of said heating means 2002a-c;
said tank 2001 being suitable for melting 2004 a mixture 1001a of raw materials;
said tank 2001 comprising at least one temperature-measuring device 2009;
said temperature-measuring device 2009 being configured to continuously measure the temperature of said mixture 1001a of molten raw materials 2004, and connected to said control device 2010;
said method 3000 comprises the following steps:
(a) continuously introducing 3001 a mixture 1001a of raw materials of a given composition into the tank 2001;
(b) continuously measuring 3002 the temperature of the mixture 1001a of molten raw materials 2004 using the temperature-measuring device 2009;
(c) stationary heating 3003 of the mixture 1001a of molten raw materials 2004 according to a given temperature, Tᵢ;
(d) modifying 3004, for a given and limited period of time, without active regulation by the control device 2010, at least one operating parameter of the furnace 1002 selected from among the moisture content in the mixture 1001a of raw materials, the pull of the furnace, the charging rate of the mixture 1001a of raw materials, the power of the heating means 2002a-c, and/or the amount of organic compounds or carbon-containing fuels in the mixture 1001a of raw materials;
(e) measuring 3005 variations as a function of time in the temperature, ΔT, of the mixture of raw materials 1001a in molten state 2004;
(f) modeling 3006, using a data processing device, the thermal behavior of the furnace 1002 using a non-stationary heat transfer function H(s) with, as input data, the variations as a function of time in the temperature ΔT of the mixture 1001a of molten raw materials and of the at least one operating parameter modified in step (d);
(g) modeling 3007, using a data processing device, the parameters of the transfer function C(s) of the control device 2010 applied to the transfer function H(s) modeled in step (f).

The temperature-measuring device 2009 may be a thermocouple or a pyrometer.

In the context of the invention, “carbon-containing fuels” relates to any type of carbon-based organic mineral fuel, preferably solid, which can be added to the mixture 1001a of raw materials. An example of a carbon-containing fuel can be coal or petroleum coke.

Modeling steps (f) and (g) are usually performed using a data processing device. An example of a device can be any device adapted to automatically execute sequences of arithmetic or logic operations to perform tasks or actions. Such a device, generally referred to as a computer, may comprise one or more central processing units (CPU) and at least one control device suitable for performing these operations.

The device may likewise include other electronic components such as input/output interfaces, non-volatile or volatile storage devices, and communication buses for transferring data between the components inside the device. One of the input/output devices can be a user interface for man-machine interaction, for example a graphical user interface for displaying human-understandable information.

The data processing device can advantageously comprise one or more graphics processing units (GPU), the parallel structure of which makes them more effective than central processing units in executing complex calculations.

Step (g) of modeling the thermal behavior of the furnace 1002 using a non-stationary heat transfer function H(s) allows a digital model of the furnace 1002 to be obtained from which it is possible to model the parameters of the transfer function C(s) of the control device 2010 without it being necessary to physically intervene on the furnace 1002 to implement this modeling. In other words, the transfer function H(s) provides a model of the furnace 1002 to which the control device 2010 can be applied, via its transfer function C(s), in order, in step (g), to determine the values of the parameters of said device for optimal regulation of the furnace 1002.

By virtue of the method according to the first aspect of the invention, it is thus possible to model or even simulate different values for the parameters of the transfer function C(s) and to select those that allow optimal regulation of the furnace 1002 without the need to physically implement disturbance tests on the furnace 1002 to evaluate said regulation. A notable advantage is that the furnace 1002 is significantly less stressed due to the adjustment of the control device 2010.

In step (f), the thermal behavior of the furnace 1002 is modeled using a non-stationary heat transfer function H(s).

According to one example of an embodiment, the thermal equilibrium of the furnace 1002 can be modeled using the following equation:

Mcₚ∂T(t)/∂t=P(t)−φ+I(t)

where T is the temperature of the furnace 1002 including the melt 2004, t is time, M is the mass of the furnace 1002 including the melt 2004 contained therein, cₚ is the heat capacity by mass of the furnace including the melt 2004, P(t) is the power of the heating means at time t, φ is the power required to melt the mixture 1001a of raw materials at a given charging rate, and I(t)=δ(t)+Ω(t) is the instantaneous variation in power associated with variations as a function of time in the content, δ(t), of moisture δ and the amount Ω(t) of organic or combustible carbon-containing compounds in the mixture 1001a of raw materials.

The power I(t) can further comprise the temporal variations in the pull ψ(t) of the furnace and/or the charging rate v(t) of the mixture 1001a of raw materials.

Generally, in the case of convective-like heat transfer, the power φ varies proportionally to the deviation between the temperature T(t) of the furnace 1002 including the melt 2004 at time t and a so-called fictitious boundary layer temperature Tₚ. The boundary layer temperature Tₚ can be interpreted as a temperature representative of the temperature of the melt 2004 in the vicinity of the walls of the furnace 1002 and the mixture 1001a of unmolten raw materials. The power φ can then be estimated using the following ratio:

φ=β(T(t)−Tₚ) where β and Tₚ are a priori unknown constants.

By positing x(t)=T(t)−T₀ and u(t)=P(t)−P₀, with T₀ as the setpoint temperature and P₀ as the base power to reach the setpoint temperature T₀ without disturbance, that is, with I(t)=0, a non-stationary heat transfer function H(s) in the Laplace domain can be:

$$X ( s ) = H ( s ) [ U ( s ) + I ( s ) ]$$

with

$$H ( s ) = \frac{1}{M {c}_{p} s + β} = \frac{1}{β} ( \frac{γ}{s + γ} )$$

and

$$γ = \frac{β}{M {c}_{p}}$$

In the initial state, that is before any disturbance of the furnace 1002, the temperature, T(t), of the furnace 1002 follows the setpoint temperature, T₀, i.e. T(t)=T₀ for base power, P₀:

$$β = \frac{{P}_{0}}{( {T}_{0} - {T}_{p} )}$$

And

$$H ( s ) = \frac{( {T}_{0} - {T}_{p} )}{{P}_{0}} ( \frac{γ}{s + γ} )$$

The values M, cₚ, Tₚ, and β are generally unknown and depend on the structure of the furnace 1002, its constituent materials, the chemical nature of the melt 2004, and its amount. β also depends on the charging rate of the mixture 1001a of raw materials.

In accordance with the first aspect of the invention, the modeling of the thermal behavior of the furnace 1002 is modeled using the transfer function H(s) with, as input data, the variations as a function of time in the temperature ΔT of the mixture 1001a of molten raw materials and the operating parameter modified in step (d). The variations as a function of time in the temperature ΔT of the mixture 1001a of molten raw materials and the operating parameter modified in step (d) can be interpreted as the consequences of a disturbance introduced by the modification, in step (d), of at least one operating parameter of the furnace. By exploiting this disturbance, the parameters of the transfer function H(s) can be calculated, especially the constant γ and the temperature Tₚ.

According to certain embodiments, the non-stationary heat transfer function H(s) is modeled using a first-order response transfer function with or without lag time.

Generally, submerged-combustion furnaces present a certain inertia, and when one of their operating parameters is suddenly modified, in the form of an impulse, the response of said 1002 furnace is not immediate. The furnace 1002 shows a delay in response to the disturbance.

According to one example of an embodiment, for a power impulse response, for example following a sudden power variation in the form of a unit step U(s)=ΔP/s, and a zero variation, ΔI=Δδ+ΔΩ=0, of the moisture content and the amount of organic compounds, the response can be written as:

$$X ( s ) = H ( s ) \frac{Δ P}{s} = \frac{( {T}_{0} - {T}_{p} )}{{P}_{0}} ( \frac{γ}{s ( s + γ )} ) Δ P$$

Where ΔP=P₁−P₀ is the variation, in the form of a unit step, from the initial power P₀ to the power P₁ different from P₀.

In the temporal domain, this function has the expression, for t>0:

$$f ( t ) = \frac{( {P}_{1} - {P}_{0} )}{{P}_{0}} ( {T}_{0} - {T}_{p} ) ( 1 - {e}^{- γ t} )$$

The values of the parameters γ and Tₚ can be obtained by adjusting a function f(t) to the variations as a function of time in the temperature ΔT of the mixture 1001a of molten raw materials and the power ΔP of the heating means 2002a-c.

In step (d), for a given and limited period of time, without active regulation by the control device 2010, at least one operating parameter of the furnace 1002 is modified selected from among the moisture content in the mixture 1001a of raw materials, the pull of the furnace, the charging rate of the mixture 1001a of raw materials, the power of the heating means 2002a-c, and/or the amount of organic compounds or carbon-containing fuels in the mixture 1001a of raw materials.

The number and nature of the operating parameters to be modified depend on the composition of the mixture of raw materials comprising mineral waste, and on the desired accuracy for calibrating the control parameters.

According to certain embodiments, in step (d), at least two or even three operating parameters are modified sequentially or in parallel. Modifying at least two, or even three parameters, is generally sufficient for representative modeling of the thermal behavior of a furnace, especially a submerged-combustion furnace, and ultimately for accurately modeling the parameters of the transfer function of the control device 2010 for effective regulation.

As stated previously, the level of moisture and content of organic compounds or carbon-containing fuels in mineral waste can vary significantly depending on its origin and how it is stored. Over the course of the operating time of a submerged-combustion furnace, a mixture of raw materials comprising mineral waste in given proportions can show sudden and significant variations in its level of moisture and its content of organic compounds or carbon-containing fuels.

Thus, according to certain embodiments, in step (d), the moisture content in the mixture 1001a of raw materials is modified so that the variation in the moisture content of said mixture is between 0 and 10%, and/or the pull of the furnace is modified so that the relative variation of said pull is between 0 and 2000 kg/h.

These intervals of variation in the pull of the furnaces and in the moisture content of the mixtures of raw materials comprising mineral waste allow an effective calibration of the control devices of the furnaces, especially submerged-combustion furnaces.

According to certain embodiments, the furnace 1002 may comprise at least one means 2011 for measuring the moisture content of said mixture 1001a of raw materials. This means can be any type of moisture sensor suitable for measuring the moisture of the mixture 1001a of raw materials. It can be arranged on the conveyor 1003 just before loading, or further upstream, in the storage silos 1001. The moisture measuring means 2011 allows for accurate measuring of the variation in the moisture content of the mixture 1001a in step (d).

According to other embodiments, in step (d), the amount of organic compounds in the mixture 1001a of raw materials is modified so that the relative variation of said amount of organic compounds or carbon-containing fuels is between 0 and 15% by weight, preferably between 0 and 10% by weight.

These variation intervals in the amount of organic compounds allow modeling of the transfer function H(s) of the furnace 1002 and, subsequently, of the transfer function C(s) of the control device 2010 which, when said function is ultimately implemented in a device 2010, leads to rapid convergence of the temperature of the furnace 1002 to the setpoint temperature in the event of sudden and intense variations in the content of organic compounds or carbon-containing fuels in the mixture of raw materials comprising mineral waste.

According to other embodiments, complementary or not, in step (d), the power of the heating means (2002a-c) is modified so that the relative variation of said power with respect to the initial power is between 0 and 100%, preferably 0 and 50%, or even between 0 and 25%.

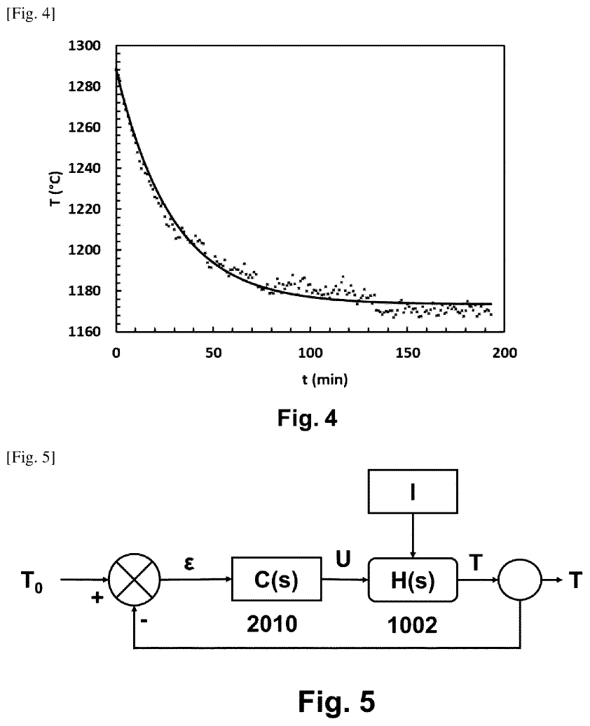

By way of illustrative example, FIG. 4 depicts the evolution of the temperature (dotted line) of a submerged-combustion furnace based on the time after the introduction of 5.7% coke by mass into a mixture 1001a of raw materials, followed by an abrupt reduction in power of the furnace from 287 kW to 173 kW. On introduction of the coke, due to the energy released by its combustion, the temperature of the furnace 1002, initially at T₀=1175 °C, rose to 1288 °C. In FIG. 4, the time t=0 corresponds to the moment when the power is abruptly reduced, in the form of a unit step, from 287 kW to 173 kW. The evolution of the temperature is represented by the dotted lines.

The response f(t) previously described for an impulse response can be written with P₀=287 kW, P₁=173 kW and T₀=1175 °C:

$$f ( t ) = \frac{( 173 - 287 )}{287} ( 1175 - {T}_{p} ) ( 1 - {e}^{- γ t} )$$

To determine the values of the parameters Tₚ and γ, the response f(t) can be adjusted to the data in FIG. 4 using a least-squares method with Tₚ and γ as the adjustment parameters. The optimal adjustment, illustrated in FIG. 4 by the solid line, yields the following values for the parameters Tₚ and γ:

$${T}_{p} = 888 °C$$

$$γ = 5. 8.1 {0}^{- 4} Hz$$

The transfer function H(s) allowing the thermal behavior to be modeled in this example can therefore be written as:

$$H ( s ) = \frac{( 1175 - 888 )}{287} ( \frac{5.8.1 {0}^{- 4}}{s + 5.8.1 {0}^{- 4}} )$$

And the value Mcₚ, representing the thermal capacity of the furnace 1002 independent of its mass, can be calculated:

$${Mc}_{p} \approx 1.7 MJ / K$$

In step (g), the parameters of the transfer function C(s) of the control device 2010 are modeled by applying it to the transfer function H(s) of the furnace 1002, obtained in step (f).

Once the thermal behavior of the furnace 1002 has been modeled using the transfer function H(s), it is possible to model the parameters of the transfer function C(s) of the control device 2010 applied to the transfer function H(s) of the furnace.

This modeling can especially be implemented by simulation in order to determine ex-situ the optimal values of the parameters of the transfer function C(s) for effective regulation of the furnace 1002. Numerical calculation software packages such as Matlab or Scilab provide functions and algorithms suitable for this type of simulation.

With reference to FIG. 5, an example of modeling can consist of an iterative optimization loop wherein the parameters of the transfer function C(s) of the control device are adjusted until the setpoint power P calculated by said function C(s) from a deviation ε between the temperature T of the furnace 1002 and a setpoint temperature T₀ for said furnace 1002 allows the furnace 1002 to reach said setpoint temperature T₀ when said power P increased by the power I(s) is supplied, as input data, to the transfer function H(s) of the furnace 1002. I(s)=δ(s)+Ω(s) is the instantaneous variation in power linked to the variations as a function of time in the content, δ(s), in moisture δ and the amount Ω(s) of organic compounds or carbon-containing fuels in the mixture 1001a of raw materials.

During execution of the iterative execution loop, the parameters of the transfer function C(s) of the control device 2010 can be adjusted manually, using an adjustment method such as the Ziegler-Nichols method, the Cohen-Coon method, the Åström-Hcgglund method, or automatically using a numerical optimization method.

With the transfer function H(s) from the example in FIG. 4, the diagram in FIG. 5 can, for example, be transcribed using the following formula:

$$X ( s ) = H ( s ) ( U ( s ) + I ( s ) )$$

$$U ( s ) = C ( s ) ε ( s )$$

With ε(t)=−x(t). Hence:

$$X ( s ) = \frac{H ( s )}{1 + H ( s ) C ( s )} I ( s )$$

In preferred embodiments, the control device 2010 is a Proportional-Integral-Derivative (PID) regulator.

The transfer function C(s) of the control device 2010 can be written as follows in the Laplace domain:

$$C ( s ) = {K}_{p} + {K}_{i} \frac{1}{s} + {K}_{d} s$$

where Kp, Ki and Kd are the proportional, integral and derivative parameters or gains respectively.

According to another notation, the transfer function C(s) can have the following form:

$$C ( s ) = {K}_{p} ( 1 + \frac{1}{{τ}_{i} s} + {τ}_{d} s )$$

where τᵢ and τ_{d} are the integration and derivative time constants respectively and, τᵢ=Kp/Ki=KpTi and τ_{d}=Kd/Kp=Td/Kp.

It has been found that, in most industrial furnaces, the temperature measurements, T, of the mixture 1001a of molten raw materials 2004 can be affected by significant noise. In order to avoid deviations in regulation, it may be advantageous to disregard the derivative term of the transfer function C(s) without any significant impact on the regulating capabilities of the control device.

The function C(s) can then be written as:

$$C ( s ) = {K}_{p} + {K}_{i} \frac{1}{s}$$

Or even

$$C ( s ) = {K}_{p} ( 1 + \frac{1}{{τ}_{i} s} )$$

The transfer function C(s) allows the real-time calculation of a gain for correcting the setpoint of the power regulators of the heating means 2002a-c in the form of at least one submerged burner. The unit of gain depends on the type of regulator used. For example, in the case of a submerged burner, it may correspond to a percentage of the fuel flow rate, for example, a gas volume flow rate, injected into the burner. The flow rate value can be linked to a burner power level according to a linear relationship.

Based on the previous example, the setpoint value at the output of the control device 2010 can be written as follows:

$$U ( s ) = {K}_{p} ( 1 + \frac{1}{{τ}_{i} s} ) ε ( s )$$

The setpoint power, P, at the inlet to the furnace 1002 can be written as:

$$P = {P}_{0} + {K}_{p} ( ε ( t ) + \frac{1}{{τ}_{i}} {\int }_{0}^{t} ε ( {t}^{′} ) {dt}^{′} )$$

Modeling the parameters, Kp and τᵢ of the transfer function C(s) of the control device 2010 can then consist of adjusting the values that minimize variations as a function of time in temperature in a simulation of the system being regulated.

This adjustment can be performed manually, using an adjustment method such as the Ziegler-Nichols method, the Cohen-Coon method, the Åström-Hägglund method, or automatically using a numerical optimization method.

For the example in FIG. 4 and using a measurement frequency a of the temperature-measuring device 2009 set higher than γ, i.e., α=1 Hz, the parameters Kp and τᵢ must be adjusted iteratively so that x(t) approaches zero over time. The advantage is that it is possible to evaluate the stability, over time, of the furnace during regulation when it is subjected to disturbances that are considered normal for applications in the glass industry. Another advantage is the ability to take into account the sampling frequency of the temperature-measuring device 2009 during modeling.

According to certain embodiments, in step (g), the transfer function H(s) of the furnace 1002 further takes, as input data, a set of simulated values, I(s), of variations in the moisture content in the mixture 1001a of raw materials, the pull of the furnace, the charging rate of the mixture 1001a of raw materials, the amount of carbon-containing organic compounds or fuels and/or the value of the setpoint temperature, T₀.

According to certain embodiments, the values of the moisture content in the mixture 1001a of raw materials, the pull of the furnace, the charging rate of the mixture 1001a of raw materials, and/or the amount of organic compounds or carbon-containing fuels are simulated as a random signal, such as white noise or pink noise.

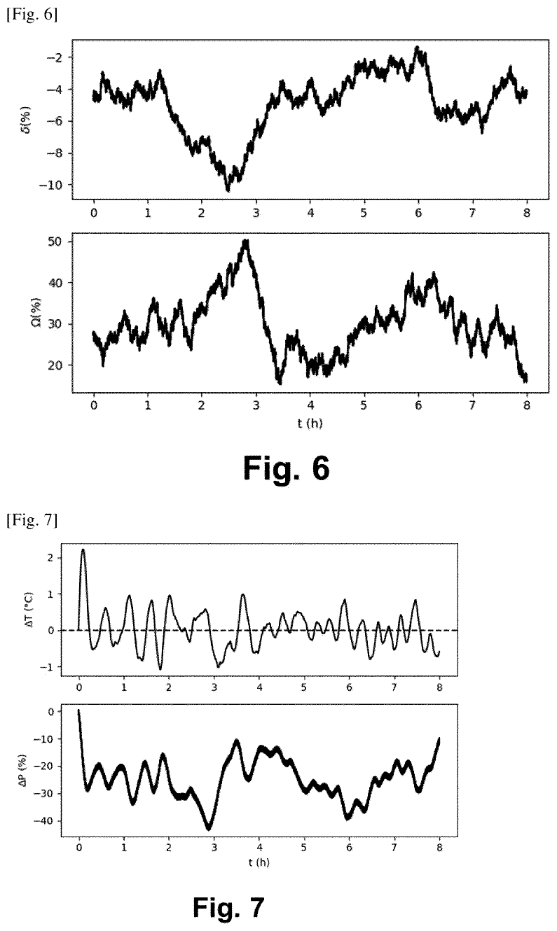

According to an example of modeling the parameters, Kp and τᵢ of the transfer function C(s) of the control device for the example of FIG. 4 and FIG. 5, referring to FIG. 6, instantaneous variations, expressed as relative variations δ(t) and Ω(t), of the power I(t)=δ(t)+Ω(t) related to variations as a function of time in moisture content (upper frame) and the amount Ω of organic compounds or carbon-containing fuels (lower frame) are first generated in the form of pink noise. The values of the parameters Kp and τᵢ are then manually adjusted by iteration so as to obtain a temperature close to the setpoint temperature over time.

In FIG. 7, the corresponding variations in power (lower frame) and temperature (continuous line, upper frame) of the furnace 1002 are represented, obtained with the following adjusted values of the parameters Kp and τᵢ:

$${K}_{p} = 2.2 kW / °C$$

$${τ}_{i} = 478 s$$

FIG. 7 shows that these values of the parameters Kp and τᵢ allow an effective automatic control of the temperature T (continuous line, upper frame) of the furnace 1002 to the setpoint temperature T₀ (discontinuous line, upper frame) across the entire set of instantaneous variations in the power I(s) of FIG. 6.

In order to validate the performance of a control device calibrated with the values of the parameters Kp and τᵢ adjusted in this way, these were implemented in the device for automatically controlling an industrial furnace presenting the same transfer function H(s) as that of the example in FIG. 4 and FIG. 5. The industrial furnace, operating under real-life industrial conditions, was then subjected to sudden variations in the setpoint temperature, T₀, in its pull, in the moisture content and in the amount of organic materials or carbon-containing fuels, such as coke, contained in the mixture of raw materials.

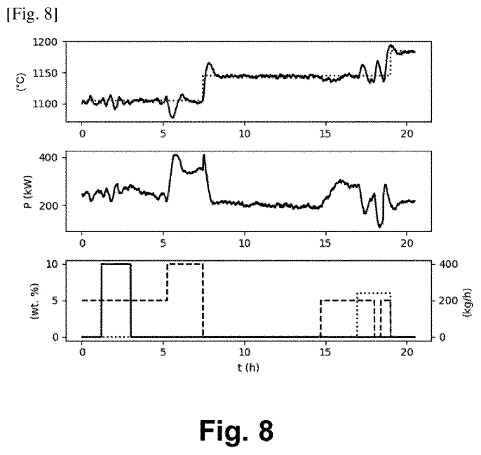

The behavior of the furnace subjected to such variations is shown in FIG. 8. The upper frame shows the temporal evolution of the temperature (upper frame, continuous line) of the furnace and the setpoint temperature T₀ (dotted line). The central frame shows the temporal evolution of the power of the furnace. The lower frame represents the sudden variations in the pull (dashed line) of the furnace, the moisture content (continuous line) and the amount of organic materials or carbon-containing fuel (dotted line) in the mixture of raw materials.

FIG. 8, upper frame, shows a rapid convergence of the temperature (continuous line) of the furnace to the setpoint temperature T₀ (dotted line), regardless of the nature and simultaneity of the variations (lower frame).

A sudden change in moisture content δ (continuous line) causes a weak disturbance of the power (central frame) and the temperature (continuous line) of the furnace deviates little from the setpoint temperature T₀ (dotted line). The sudden variations in the pull of the furnace ψ (lower frame, dashed line) after 5 h and shortly before 15 h cause sudden variations in power (central frame), and the temperature (continuous line), after an initial derivation, converges very rapidly towards the setpoint temperature T₀ (dotted line). The sudden variation in the amount Ω of organic materials or carbon-containing fuels (lower frame, dotted line) at around 17 h leads to frequent variations in power, which are quickly compensated for.

Furthermore, the control device is able to compensate for sudden and simultaneous variations, after 7:30 a.m. and 7:00 p.m., in the setpoint temperature T₀ (upper frame, dotted line), the pull of the furnace (lower frame, dashed line), the moisture content (lower frame, continuous line) and the amount of organic materials or carbon-containing fuels (lower frame, dotted line).

The tests shown in FIG. 8 demonstrate that the present invention allows effective and robust calibration of a device for automatically controlling a submerged-combustion furnace. The control device 2010 allows rapid compensation for sudden and intense variations in setpoint temperature, T₀ (variations of 40 °C in the figure), moisture content in the mixture 1001a of raw materials, pull of the furnace, charging rate of the mixture 1001a of raw materials, and/or the amount of organic compounds in the mixture 1001a of raw materials. The temperature of the furnace 1002 converges rapidly to the setpoint temperature, with very limited overshoot amplitudes over time, regardless of the nature and simultaneity of the variations.

All the embodiments of the first aspect of the invention can be combined.

The method according to the first aspect of the invention can advantageously be used for calibrating a device 2010 for automatically controlling 2010 a furnace 1002, preferably a submerged-combustion furnace, for melting a mixture 1001a of raw materials comprising mineral waste.

According to a second aspect of the invention, referring to FIG. 2 and FIG. 3, a method is provided for calibrating the parameters of a device 2010 for automatically controlling a furnace 1002, preferably a submerged-combustion furnace, for melting a mixture 1001a of raw materials comprising mineral waste,
the furnace 1002 comprises at least one tank 2001 equipped with at least one heating means 2002a-c in the form of at least one submerged burner;
the tank 2001 is suitable for melting 2004 a mixture 1001a of raw materials;
said system comprises:
at least one temperature-measuring device 2009, said temperature-measuring device 2009 being configured to continuously measure the temperature of said mixture 1001a of molten raw materials 2004;
at least one control device 2010 configured to regulate the power of said heating means 2002a-c; the parameters of the transfer equation C(s) of said control device 2010 being calibrated using a method according to any one of the embodiments of the first aspect of the invention.

According to a third aspect of the invention, a furnace 1002, preferably a submerged-combustion furnace, is provided for melting 2004 a mixture 1001a of raw materials comprising mineral waste, said furnace 1002 comprising:
a first tank 2001 suitable for melting 2004 a mixture of raw materials and equipped with at least one heating means 2002a-c in the form of at least one submerged burner,
at least one temperature-measuring device 2009 to continuously measure the temperature of said mixture 1001a of molten raw materials 2004;
at least one control device 2010 configured to regulate the power of said heating means 2002a-c and to receive at least one continuous temperature measurement using said temperature-measuring device 2009; the values of the parameters of the transfer function C(s) of the control device 2010 being fixed from values obtained using a calibration method according to any one of the embodiments of the first aspect of the invention.

The calibration method allowing the values of the parameters of the transfer function C(s) of the control device 2010 to be determined can be implemented using a system according to the second aspect of the invention.

As with the first aspect of the invention, the furnace 1002 may comprise at least one means 2011 for measuring the moisture content of said mixture 1001a of raw materials.

According to certain embodiments, the heating means 2002a-c is an oxygen/air-fuel submerged burner and the control device 2010 is further configured to regulate the power of said submerged burner by adjusting the fuel flow rate injected into said burner while maintaining a constant oxygen flow rate to fuel flow rate ratio.

According to certain embodiments, the heating means 2002a-c is an oxygen/air-fuel submerged burner and the control device 2010 is further configured to inject oxygen or air according to a constant total flow rate of oxygen or air into said burner and into a bubbler, and according to a constant oxygen or air flow rate to fuel flow rate ratio into the burner as the power of the submerged burner varies.

In a fourth aspect of the invention, an installation for manufacturing mineral fibers, such as a glass or rock fiber manufacturing line, is provided, comprising a furnace 1002 according to any one of the embodiments of the third aspect of the invention.

The present invention, in all its aspects, can be implemented, without being limited thereto, in numerous processes and manufacturing lines for glass products such as, for example, glass wool, rock wool, textile glass fibers, flat glass, or hollow glass.

### LIST OF REFERENCES

### Patent Literature

U.S. Pat. No. 351,413 B, J. T. WAINWRIGHT Oct. 26, 1886.
U.S. Pat. No. 1,656,828 A, POWELL EDWARD R, Jan. 17, 1928.
FR 876569 A, UNION DES VERRERIES MECANIQUES, Nov. 10, 1942.
WO 2009 091 558A1, GAS TECHNOLOGY INST [US] Jul. 29, 2009.
DE 651 687 C, GLASHUETTE ACHERN A G, Oct. 18, 1937.
GB 1 028 481 A, SELAS CORP OF AMERICA, May 4, 1966.
WO 0248612 A1, SAINT GOBAIN [FR] Jun. 20, 2002.
WO 2006 018 582 A1, SAINT GOBAIN ISOVER [FR] Feb. 23, 2006.
U.S. Pat. No. 4,877,449 A, INST GAS TECHNOLOGY [US] Oct. 31, 1989.
EP 2 433 911 A1, JOHNS MANVILLE [US] Mar. 28, 2012.
WO 2022 180 345A1, SAINT GOBAIN ISOVER [FR] Sep. 1, 2022.

1. A method for calibrating parameters of a device for automatically controlling a furnace for melting a mixture of raw materials comprising mineral waste,
said furnace comprising at least one tank equipped with at least one heating means and at least one control device configured to regulate a power of said heating means according to a setpoint temperature, T₀;
said tank being suitable for melting a mixture of raw materials;
said tank comprising at least one temperature-measuring device;
said temperature-measuring device being configured to continuously measure the temperature of said mixture of molten raw materials, and connected to said control device;
said method comprises the following steps:
(a) continuously introducing a mixture of raw materials of a given composition into the tank;
(b) continuously measuring the temperature of the mixture of molten raw materials using the temperature-measuring device;
(c) stationary heating of the mixture of molten raw materials according to a given temperature, Tᵢ;
(d) modifying, for a given and limited period of time, without active regulation by the control device, at least one operating parameter of the furnace selected from the moisture content in the mixture of raw materials, a pull of the furnace, the charging rate of the mixture of raw materials, the power of the heating means, and/or the amount of organic compounds or carbon-containing fuels in the mixture of raw materials;
(e) measuring the variations as a function of time in the temperature, ΔT, of the mixture of raw materials in molten state and of the power ΔP of the heating means;
(f) modeling, using a data processing device, the thermal behavior of the furnace using a non-stationary heat transfer function H(s) with, as input data, the variations as a function of time in the temperature ΔT of the mixture of molten raw materials and of the at least one operating parameter modified in step (d);
(g) modeling, using a data processing device, the parameters of the transfer function of the control device applied to the transfer function H(s) modeled in step (f).

2. The method according to claim 1, such that the non-stationary heat transfer function H(s) is modeled using a first-order response transfer function with or without lag time.

3. The method according to claim 1, such that, in step (d), at least two parameters are modified sequentially or in parallel.

4. The method according to claim 1, such that, in step (d), the moisture content in the mixture of raw materials is modified so that the variation in the moisture content of said mixture is between 0 and 10%, and/or the pull of the furnace is modified so that the relative variation of said pull is between 0 and 2000 kg/h.

5. The method according to claim 1, such that, in step (d), the amount of organic compounds or carbon-containing materials in the mixture of raw materials is modified so that the relative variation of said amount of organic compounds or carbon-containing fuels is between 0 and 15% by weight.

6. The method according to claim 1, such that, in step (d), the power of the heating means is modified so that the relative variation of said power with respect to the initial power is between 0 and 100%.

7. The method according to claim 1, such that the control device is a Proportional-Integral-Derivative (PID) regulator.

8. The method according to claim 1, such that, in step (g), the transfer function H(s) of the furnace further takes, as input data, a set of simulated values, I(s), of variations in the moisture content in the mixture of raw materials, the pull of the furnace, the charging rate of the mixture of raw materials, the amount of carbon-containing organic compounds or fuels and/or the value of the setpoint temperature, T₀.

9. The method according to claim 8, such that the values of the moisture content in the mixture of raw materials, the pull of the furnace, the charging rate of the mixture of raw materials, and/or the amount of organic compounds or carbon-containing fuels are simulated as a random signal.

10. A method comprising performing a method according to claim 1 for calibrating a device for automatically controlling a furnace for melting a mixture of raw materials comprising mineral waste.

11. A system for calibrating the parameters of a device for automatically controlling a furnace for melting a mixture of raw materials comprising mineral waste,
the furnace comprises at least one tank equipped with at least one heating means in the form of at least one submerged burner;
the tank is suitable for melting a mixture of raw materials; said system comprises:
at least one temperature-measuring device, said temperature-measuring device being configured to continuously measure the temperature of said mixture of molten raw materials;
at least one control device configured to regulate the power of said heating means; the parameters of the transfer equation C(s) of said control device being calibrated using a method according to claim 1.

12. A furnace for melting a mixture of raw materials comprising mineral waste, said furnace comprising:
a first tank suitable for melting a mixture of raw materials and equipped with at least one heating means in the form of at least one submerged burner,
at least one temperature-measuring device to continuously measure a temperature of said mixture of molten raw materials;
at least one control device configured to regulate the power of said heating means and to receive at least one continuous temperature measurement using said temperature-measuring device; the values of the parameters of the transfer function C(s) of the control device being fixed from values obtained using a calibration method according to claim 1.

13. The furnace according to claim 12, such that the heating means is an oxygen/air-fuel submerged burner and the control device is further configured to regulate the power of said submerged burner by adjusting the fuel flow rate injected into said burner while maintaining a constant oxygen flow rate to fuel flow rate ratio.

14. The furnace according to claim 12, such that the heating means is an oxygen/air-fuel submerged burner and the control device is further configured to inject oxygen or air according to a constant total flow rate of oxygen or air into said burner and into a bubbler, and according to a constant oxygen or air flow rate to fuel flow rate ratio into the burner as the power of the submerged burner varies.

15. An installation for manufacturing mineral fibers comprising a submerged-combustion furnace according to claim 12.

16. The method according to claim 1, wherein the furnace is a submerged-combustion furnace.

17. The method according to claim 1, wherein the at least one heating means includes at least one submerged burner.

18. The method according to claim 3, such that, in step (d), at least three parameters are modified sequentially or in parallel.

19. The method according to claim 5, such that, in step (d), the amount of organic compounds or carbon-containing materials in the mixture of raw materials is modified so that the relative variation of said amount of organic compounds or carbon-containing fuels is between 0 and 10% by weight.

20. The method according to claim 6, such that, in step (d), the power of the heating means is modified so that the relative variation of said power with respect to the initial power is between 0 and 50%.
